(19) United States
(12) Patent Application Publication
(10) Pub. No.: US 2007/0300177 A1
(43) Pub. Date: Dec. 27, 2007

(54) User interface for specifying multi-valued properties

(75) Inventors: Benjamin J. Karas, Redmond, WA (US); Paul A. Gusmorino, Redmond, WA (US); Scott S. Hysom, Redmond, WA (US); Timothy P. McKee, Redmond, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/473,464

(22) Filed: Jun. 23, 2006

(51) Int. Cl. G06F 3/048

(52) U.S. Cl. 715/780

(57) ABSTRACT

A system, apparatus, method, and computer-readable media are provided for specifying and editing the values of a multi-valued property. According to one method, a field is displayed for entering the values of the multi-valued property. A selection or alphanumeric characters may be received in the field. In response to receiving one or more alphanumeric characters in the field, one or more possible values for the field are identified based on the received alphanumeric characters. In response to receive a selection of the field, one or more suggested values for the field are identified. A menu is then displayed adjacent to the field. The menu includes the suggested or possible values and is presented in a manner that allows each of the values to be individually selectable as a value of the property. Multiple possible values may be simultaneously selected from the menu. Once the desired values have been selected, the selected values are inserted into the field.

### CROSS-REFERENCE TO RELATED APPLICATIONS

This application is related to co-pending non-provisional U.S. patent application Ser. No. 11/111,968, which was filed on Apr. 22, 2005 and entitled “System and Method for Viewing and Editing Multi-Value Properties,” which is expressly incorporated herein by reference in its entirety.

### BACKGROUND

Application programs and operating systems frequently allow users to edit property values associated with files or objects. For instance, a word processing application program may allow a user to view and edit property values that identify the authors of a document, keywords associated with the document, and other properties. Similarly, a shell browser provided by an operating system may allow a user to view and modify property values for files accessible through the browser. For instance, a user may utilize the shell browser to specify the file type or creator of a file.

In some cases, a property may have more than one value associated with it. This type of property is referred to as a multi-valued property. For example, the addressee field of an electronic mail message may be considered a multi-valued property as it may specify multiple recipients for the message. As another example, a document may have multiple authors and multiple keywords that describe the contents of the document.

It has previously been difficult for users to edit the property values in multi-valued property fields. One reason for the difficulty stems from the delimiters, such as semicolons or commas, that are often utilized to separate the multiple values in the displayed multi-valued property field. In some cases users fail to notice the delimiters, accidentally delete the delimiters, or accidentally insert too many delimiters. These errors can be frustrating for a user and, in some cases, difficult for a user to detect.

Using previous solutions for editing multi-valued properties, users have also been forced to add each property value to the field of a multi-valued property one at a time. When it is necessary to add many property values to a multi-valued property, this process can become time consuming and frustrating for a user.

It is with respect to these considerations and others that aspects of a computing system that provides a user interface for editing multi-valued properties are described below.

### SUMMARY

A system, apparatus, method, and computer-readable media are provided for specifying and editing the values of a multi-valued property. Through the embodiments described herein, a user can quickly and easily add multiple values to a multi-valued property.

According to one aspect provided herein, a method is provided for specifying the values of a multi-valued property that is capable of having multiple values. According to the method, a field is displayed for entering the values of the multi-valued property. Alphanumeric characters may be received in the field. In response to receiving one or more alphanumeric characters in the field, one or more possible values for the field are identified based on the received alphanumeric characters. A menu is then displayed adjacent to the field. The menu includes the possible values and is presented in a manner that allows each of the possible values to be individually selected as a value of the property. Multiple possible values may be simultaneously selected from the menu. Once the desired values have been selected, the selected possible values are inserted into the field as values for the corresponding multi-valued property.

According to other aspects of the method, the menu may further include a selectable area displayed adjacent to each of the possible values. The selectable area may be selected to thereby select the adjacent value for insertion into the field. Each selectable area may also be deselected to thereby remove the adjacent value from the field. The selectable area may also include an indicator for indicating whether the possible value has been selected.

According to another method, a selection may be received in the field. In response to the selection, one or more suggested values for the field are identified. The menu is then displayed adjacent to the field, with each of the suggested values being individually selectable as a value of the multi-valued property. Multiple suggested values may be simultaneously selected from the menu. Once the desired values have been selected, the selected suggested values are inserted into the field as values for the corresponding multi-valued property.

The above-described subject matter may also be implemented as a computer-controlled apparatus, a computer process, a computing system, or as an article of manufacture such as a computer program product or computer-readable medium. The computer program product may be a computer storage media readable by a computer system and encoding a computer program of instructions for executing a computer process. The computer program product may also be a propagated signal on a carrier readable by a computing system and encoding a computer program of instructions for executing a computer process. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a computer architecture diagram suitable for implementing a computer system utilized in the embodiments described herein;

FIGS. 2-5D are user interface diagrams illustrating aspects of a user interface control for specifying and editing the values of a multi-valued property as described herein; and

FIG. 6 is a state diagram illustrating the operation of the user interface control discussed with reference to FIGS. 2-5D.

### DETAILED DESCRIPTION

The following detailed description is directed to systems, methods, apparatuses, and computer-readable media for specifying and editing the values of a multi-valued property. While the subject matter described herein is presented in the general context of program modules that execute in conjunction with the execution of an operating system or an application program on a computer system, those skilled in the art will recognize that other implementations may be performed in combination with other types of program modules.

Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like. The subject matter described herein is also described as being practiced in a distributed computing environment where tasks are performed by remote processing devices that are linked through a communications network and wherein program modules may be located in both local and remote memory storage devices. It should be appreciated, however, that the implementations described herein may also be utilized in conjunction with stand-alone computer systems and other types of computing devices.

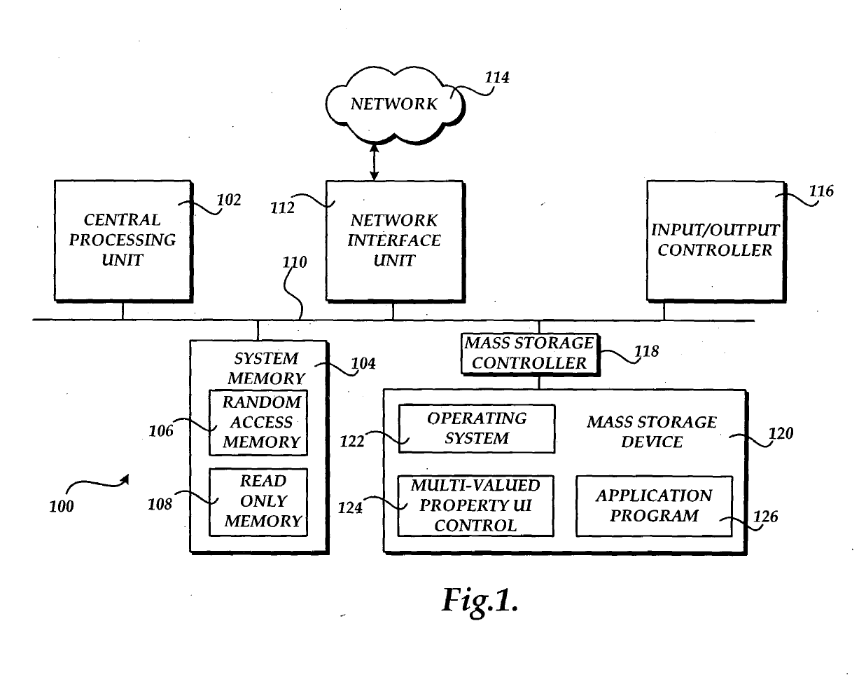

In the following detailed description, references are made to the accompanying drawings that form a part hereof, and which are shown by way of illustration specific embodiments or examples. Referring now to the drawings, in which like numerals represent like elements through the several figures, aspects of the embodiments provided herein for editing a multi-valued property will be described. FIG. 1 includes a brief, general description of a suitable computing environment in which the subject matter described herein may be implemented. In particular, FIG. 1 shows an illustrative computer architecture for a computing device 100 capable of implementing the embodiments described herein. It should be appreciated that although the computer architecture shown in FIG. 1 embodies a standard laptop, desktop computer, or server computer, other types of computer architectures and computing devices may be utilized. In particular, the subject matter described herein may be utilized with a conventional desktop or “personal” computer, a laptop computer, a handheld or portable computing device, a server computer, a wireless handset, such as a cellular or PCS telephone, a personal digital assistant, a custom hardware device, and virtually any other type of computing device.

The computer architecture shown in FIG. 1 includes a central processing unit 102 (“CPU”), a system memory 104, including a random access memory 106 (“RAM”) and a read-only memory (“ROM”) 108, and a system bus 110 that couples the memory to the CPU 102. A basic input/output system containing the basic routines that help to transfer information between elements within the computer, such as during startup, is stored in the ROM 108. The computing device 100 further includes a mass storage device 120 for storing an operating system 122, application programs, and other program modules, described in greater detail below.

The mass storage device 120 is connected to the CPU 102 through a mass storage controller 118 connected to the bus 110. The mass storage device 120 and its associated computer-readable media provide non-volatile storage for the computing device 100. Although the description of computer-readable media contained herein refers to a mass storage device, such as a hard disk or CD-ROM drive, it should be appreciated by those skilled in the art that computer-readable media can be any available media that can be accessed by the computing device 100.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computing device 100.

According to various embodiments of the subject matter described herein, the computing device 100 may operate in a networked environment using logical connections to remote computers through a network 114, such as the Internet. The computing device 100 may connect to the network 114 through a network interface unit 112 connected to the bus 110. It should be appreciated that the network interface unit 112 may also be utilized to connect to other types of networks and remote computer systems. The computing device 100 may also include an input/output controller 116 for receiving and processing input from a number of other devices, including a keyboard, mouse, or electronic stylus (not shown in FIG. 1). Similarly, an input/output controller 116 may provide output to a display screen, a printer, or other type of output device (also not shown in FIG. 1).

As mentioned briefly above, a number of program modules and data files may be stored in the mass storage device 120 and RAM 106 of the computing device 100, including an operating system 122 suitable for controlling the operation of a networked personal computer, such as the WINDOWS XP operating system from MICROSOFT CORPORATION of Redmond, Wash. Other operating systems may also be utilized, such as the LINUX operating system, the OSX operating system from APPLE COMPUTER, INC, and others. The mass storage device 120 and RAM 106 may also store one or more program modules. In particular, the mass storage device 120 and the RAM 106 may store an application program 126 and a multi-valued property user interface (“UI”) control 124. As will be described in greater detail below, the multi-valued property UI control 124 may be utilized by the operating system 122 and the application program 126 to allow a user to specify and edit the values of multi-valued properties. As described herein, the term multi-valued property refers to a property that may have more than one value. The UI control 124 may be instantiated and utilized as needed by the operating system 122 and the application program 126.

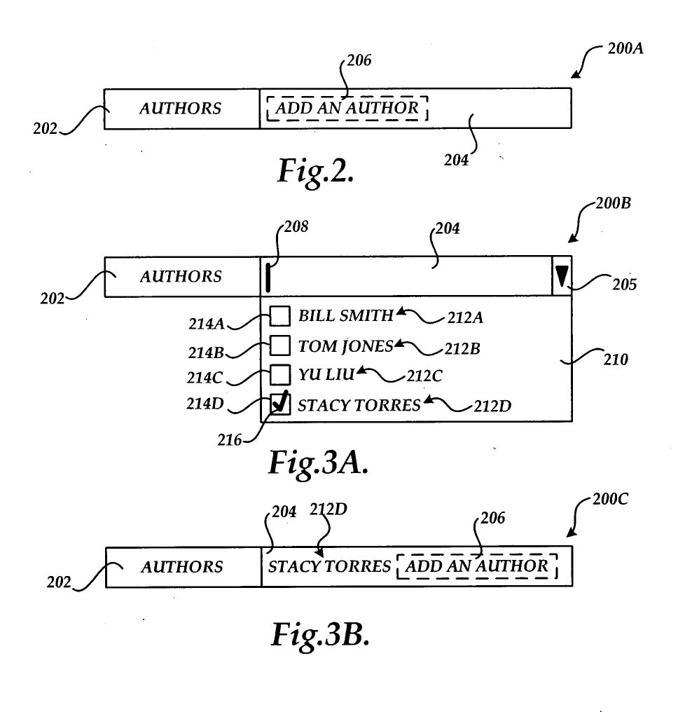

The UI control 124 may be utilized by virtually any type of operating system or application program. For instance, the UI control 124 may be utilized by the operating system 122 to specify values of properties for files accessible via a file system shell browser provided by the operating system 122. The UI control 124 may also be utilized by an application program 126 to specify recipients of electronic mail messages, properties for word processing or other types of documents, and virtually any other type of multi-valued property. It should be appreciated that these examples are merely illustrative and that the UI control 124 described herein may be utilized to specify values for any multi-valued property. Additional details regarding the operation of the UI control 124 are provided below with reference to FIGS. 2-6.

Referring now to FIGS. 2-3B, additional details regarding the operation and use of the UI control 124 according to one embodiment will be provided. FIG. 2 shows an illustrative screen display 200A provided by the UI control 124 when instantiated. As shown in FIG. 2, the screen display 200A includes a field 204 where user input may be received for entering the values of a multi-valued property. A field descriptor 202 may be displayed adjacent to the field 204 for providing a text description of the multi-valued property being edited. For instance, the example shown in the screen display 200A is configured for specifying the authors of a document. The authors property in this example is a multi-valued property because multiple authors may be specified. As also shown in FIG. 2, a prompt string 206 may also be displayed in the field 204. The prompt string 206 provides a textual indication as to where the display should be selected to add a new value to the field 204. The prompt string 206 may be displayed with a visual indicator to provide a hint that it may be selected. For instance, in FIG. 2 the prompt string 206 is displayed inside a dashed box. Other types of visual indicators may also be utilized, such as bold or colored text, highlighting, flashing text, or others.

FIG. 3A shows a screen display 200B illustrating the display provided by the UI control 124 following the selection of the prompt string 206. In this embodiment, selection of the prompt string 206, such as through selection by a mouse click or equivalent keyboard command, causes the prompt string 206 to be removed and an insertion point 208 to be placed within the field 204. The insertion point 208 signifies the location that typed characters will appear within the display 200B. In this embodiment, selection of the prompt string 206 also causes a menu 210 to be displayed adjacent to the field 204. Selection of the UI button 205 may also cause the menu 210 to be displayed in one implementation.

As shown in FIG. 3A, the menu 210 includes one or more suggested values 212A-212D for the field 204. In this example, the suggested values 212A-212D have been displayed in the menu 210 in response to the selection of the prompt string 206 or the UI button 205. Each of the suggested values 212A-212D may be individually selected for inclusion in the field 204. In particular, in one implementation, the check boxes 214A-214D are displayed adjacent to each of the respective values 212A-212D. Selection of a check box causes the corresponding value to be added to the field 204. For instance, in FIG. 3A a check 216 has been placed in the check box 214D corresponding to the value 212D. This causes the value 212D to be placed in the field 204. This is illustrated in the screen display 200C shown in FIG. 3B. It should be appreciated that any number of the values 212A-212D may be displayed in the menu 210 and that any number of the values may be selected in the manner described above for inclusion in the field 204. It should also be appreciated that the values selected and included in the field 204 become values of the multi-valued property associated with the UI control.

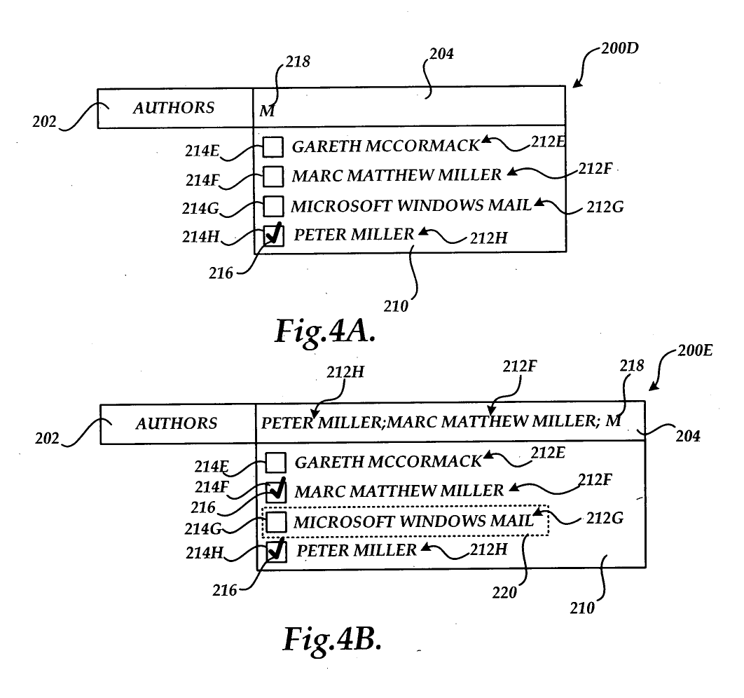

Referring now to FIG. 4A, a screen display 200D showing an alternative embodiment of the user interface control provided herein will be described. In this implementation, the screen display 200D includes the field 204, the field descriptor 202, and the prompt string 206. However, in this implementation, the menu 210 is displayed in response to receiving one or more typed alphanumeric characters in the field 204. For instance, in the screen display 200D shown in FIG. 4A, the character “M” has been typed in the field 204. In response to the receiving the typed character, the menu 210 has been displayed with a number of possible values 212E-212H for the field 204. In this implementation, the possible values 212E-212H are selected based on the alphanumeric characters typed in the field 204. So, for example, because the letter “M” was typed in the field 204, the possible values 212E-212H were selected that also included the letter “M.” It should be appreciated that the possible values 212E-212H may be continually modified based upon additional characters typed in the field 204. In this manner, the values 212E-212H become more specific as the number of characters typed in the field 204 increases.

As also shown in FIG. 4A, each of the values 212E-212H is individually selectable for inclusion in the field 204. In this regard, the check boxes 214E-214H may be displayed adjacent to each of the possible values 212E-212H. Selection of a check box will cause the corresponding value to be included in the field 204. For instance, in FIG. 4A, the check box 214H causes a check 216 to be displayed and the corresponding value 212H to be placed in the field 204. FIG. 4B shows an illustrative screen display 200E where the values 212F and 212H have been selected for inclusion in the field 204. In this example, a box 220 has been placed around the value 212G to signify an active value 212G when a keyboard is utilized to navigate the menu. It should be appreciated that de-selection of a previously checked check box causes the corresponding value to be removed from the field 204.

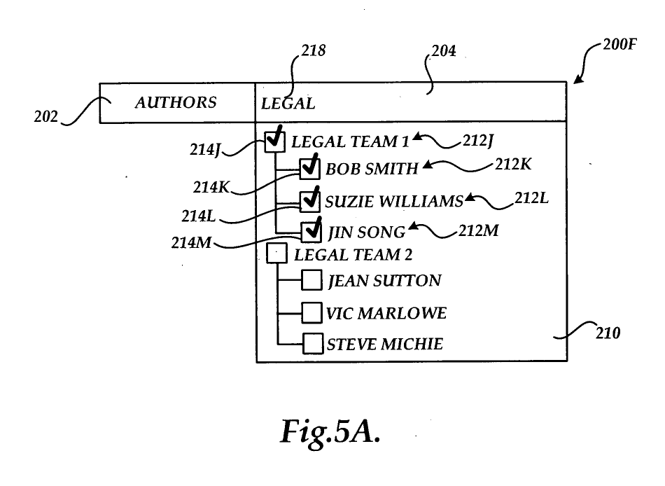

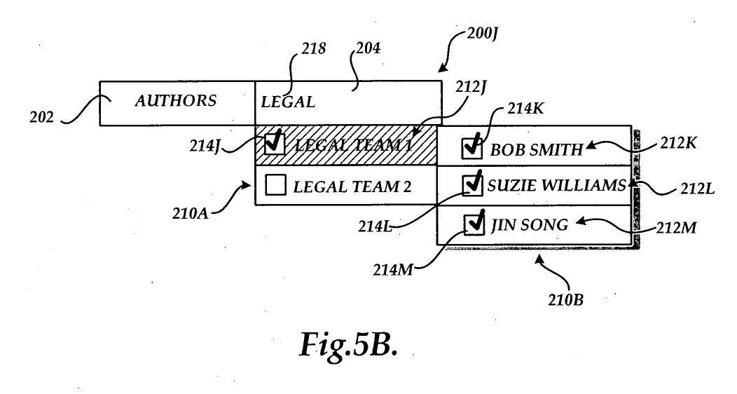

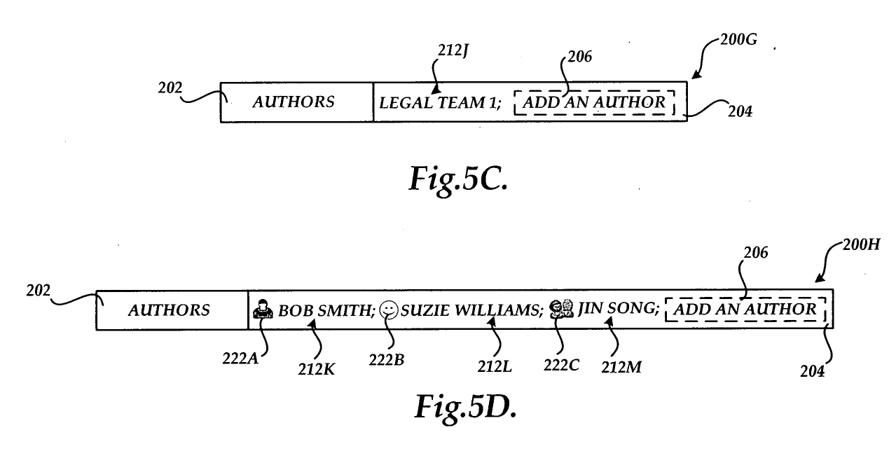

Referring now to FIG. 5A, a screen display 200F will be described showing an alternative screen display provided by the UI control 124. In this example, the values 212J-212M are displayed in the menu 210 in a hierarchical format. This may be useful, for example, for specifying hierarchies of possible values for the multi-valued property. For instance, in the example shown in FIG. 5A, the characters 218 spelling “LEGAL” have been typed in the field 204. In response, a number of possible values 212J-212M have been displayed in the menu 210. These values are displayed in a manner that conveys their hierarchical relationships to one another. In particular, the a value 212J is displayed which, when selected using the parent check box 214J will cause each of the child values 212K-212M to also be selected. In response, check marks are placed in each of the check boxes 214J-214M. Alternatively, each of the child values 212K-212M can also be selected individually.

Referring now to FIG. 5B, a screen display 200J will be described showing an alternative screen display provided by the UI control 124. In this example, the values 212J-212M are displayed using a menu 210A and a sub-menu 210B. This arrangement is also useful for specifying hierarchies of possible values for the multi-valued property. For instance, in the example shown in FIG. 5B, the characters 218 spelling “LEGAL” have been typed in the field 204. In response, a number of possible values have been displayed in the menu 210A. When one of the values is selected, such as the value 212J, a sub-menu 210B is displayed that shows the child values 212K-212M for the selected value 212J. The sub-menu 210B is displayed in a manner that conveys the hierarchical relationship of the child values 212K-212M to the parent value 212J. Selection of the value 212J using the parent check box 214J will cause each of the child values 212K-212M to also be selected. In response, check marks are placed in each of the check boxes 214K-214M. Alternatively, each of the child values 212K-212M in the sub-menu 210B can also be selected individually using the check boxes 214K-214M.

FIG. 5C shows a screen display 200G following the selection of the value 212J in FIG. 5A. In this implementation, the value 212J has been tokenized and included in the field 204. FIG. 5D shows a screen display 200H illustrating an alternative implementation, wherein each of the values 212K-212M are shown individually in the field 204 in response to the selection of the value 212J. In this embodiment, an icon 222A-222C is also displayed in the field 204 adjacent to the respective value 212K-212M. It should be appreciated that icons or other visual indicators may be displayed adjacent to specified values in the field 204 in any of the embodiments described herein.

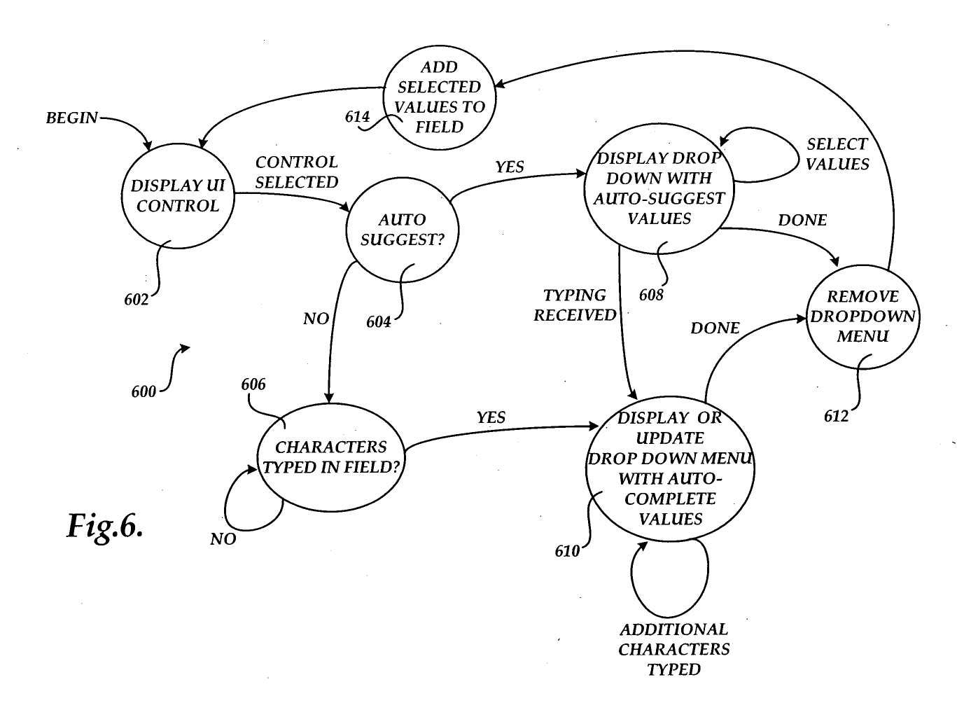

Turning now to FIG. 6, an illustrative routine 600 will be described showing the operation of the computer system 100 for providing a user interface for specifying the values of multi-valued properties. It should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance requirements of the computing system. Accordingly, the logical operations described herein with respect to are referred to variously as operations, structural devices, acts, or modules. These operations, structural devices, acts and modules may be implemented in software, in firmware, in special purpose digital logic, and any combination.

The routine 600 begins at processing operation 602, where the screen display provided by the UI control 124 described herein is displayed. The routine 600 then continues to operation 604 in response to the selection of the control. This may occur, for instance, through the use of a mouse input device or keyboard command selecting the screen display provided by the control. At operation 604, a determination is made as to whether values should be automatically suggested in response to the selection of the control in the manner described above with respect to FIGS. 2-3B. If values are to be automatically suggested, the routine 600 branches to operation 608, where the menu 210 is displayed with the suggested values. If values are not to be automatically suggested, the routine 600 branches from operation 604 to operation 606. It should be appreciated that the UI control 124 may be programmed to either suggest values or not suggest values.

At operation 606, a determination is made as to whether characters have been typed in the field 204. If so, the routine 600 branches to operation 610. The routine 600 also branches to operation 610 if characters are typed in the field while at operation 608. At operation 610, the menu 210 is displayed with possible values based on the typed characters. At operations 608 and 610, a user may select values in the menu for inclusion in the field 204. When the user has completed selecting values, the routine 600 branches from operations 608 and 610 to operation 612 where the menu 210 is removed from the screen display. The routine 600 then continues from operation 612 to operation 614 where the selected values are added to the field 204, thereby specifying the selected values as properties of the corresponding multi-valued property. The routine 600 then returns to operation 602 from operation 614, where it begins again.

Although the subject matter presented herein has been described in language specific to computer structural features, methodological acts, and computer readable media, it is to be understood that the invention defined in the appended claims is not necessarily limited to the specific features, acts, or media described herein. Rather, the specific features, acts and mediums are disclosed as example forms of implementing the claims. The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

What is claimed is:

1. A method for specifying the values of a property capable of having multiple values, the method comprising:
displaying a field for entering the values of the property;
receiving one or more alphanumeric characters in the field;
in response to receiving the characters in the field, identifying one or more possible values for the field based on the alphanumeric characters;
displaying a menu adjacent to the field, the menu comprising the possible values, each of the possible values being individually selectable as a value of the property;
receiving the selection of one or more of the possible values; and
in response to the selection of the one or more of the values, inserting all of the selected possible values into the field.

2. The method of claim 1, wherein the menu further comprises a selectable area displayed adjacent to each of the possible values, and wherein each selectable area may be selected to thereby select the adjacent value for insertion into the field.

3. The method of claim 2, wherein each selectable area may further be deselected to thereby remove the adjacent value from the field.

4. The method of claim 3, wherein each selectable area further comprises an indicator for indicating whether the adjacent possible value has been selected.

5. The method of claim 4, wherein the selectable area comprises a check box user interface object.

6. A computer-readable medium having computer-executable instructions stored thereon which, when executed by a computer, cause the computer to perform the method of claim 1.

7. A computer-controlled apparatus operative to perform the method of claim 1.

8. A method for editing the values of a property capable of having multiple values, the method comprising:
displaying a field for entering the values;
receiving a selection of the field,
in response to the selection of the field, displaying a menu adjacent to the field, the menu comprising one or more suggested values for the field, each of the suggested values being individually selectable;
receiving the selection of one or more of the values; and
in response to the selection of the one or more of the values, inserting the selected values into the field.

9. The method of claim 8, wherein each of the suggested values is displayed with a corresponding selection control which, when selected, will cause the corresponding suggested value to be selected.

10. The method of claim 9, wherein the selection control comprises a check box.

11. The method of claim 10, wherein the field further comprises a prompt string and wherein receiving a selection of the field comprises receiving a selection of the prompt string.

12. The method of claim 11, wherein the suggested values for the field are displayed hierarchically.

13. The method of claim 11, further comprising:
displaying an indicator adjacent to the field;
receiving a selection of the indicator; and
in response to receiving the selection of the indicator, displaying the menu.

14. A computer-readable medium having computer-executable instructions stored thereon which, when executed by a computer, cause the computer to perform the method of claim 8.

15. A computer-controlled apparatus operative to perform the method of claim 8.

16. A computer-readable medium having computer executable instructions stored thereon which, when executed by a computer, cause the computer to:
provide a user interface control for specifying and editing the values of a multi-valued property, the user interface control operative to display a field for entering the values, receive a selection of the field, display a menu having one or more individually selectable suggested values for the field, receive the selection of one or more of the values, and to insert the selected values into the field.

17. The computer-readable medium of claim 16, comprising further computer-executable instructions which, when executed by the computer, cause the user interface control further to receive one or more alphanumeric characters in the field, in response to receiving the characters in the field, identify one or more possible values for the field based on the alphanumeric characters, to display the possible values in the menu, each receive the selection of one or more of the possible values, and in response to the selection of the one or more of the values, to insert all of the selected possible values into the field.

18. The computer-readable medium of claim 17, wherein the menu further comprises a selectable area displayed adjacent to each of the values, and wherein each selectable area may be selected to thereby select the adjacent value for insertion into the field.

19. The computer-readable medium of claim 18, wherein each selectable area may further be deselected to thereby remove the adjacent value from the field.

20. The computer-readable medium of claim 19, wherein each selectable area further comprises an indicator for indicating whether the adjacent possible value has been selected.
